(19) United States
(12) Patent Application Publication
(10) Pub. No.: US 2002/0167761 A1
(43) Pub. Date: Nov. 14, 2002

(54) Disk drive having multi-coil solenoid

(76) Inventor: Michael P. Nelson, Kaysville, UT (US)

Correspondence Address: Woodcock Washburn Kurtz, Mackiewicz & Norris LLP, One Liberty Place - 46th Floor, Philadelphia, PA, 19103, US

(21) Appl. No.: 09/851,241

(22) Filed: May 8, 2001

(51) Int. Cl. G11B 5/54

(52) U.S. Cl. 360/256.3

(57) ABSTRACT

A storage drive receives thereinto, retains, and ejects therefrom a removable storage media cartridge having storage media. The storage drive has an actuator including a carriage assembly with a head mounted thereto. The actuator moves the head as mounted to the carriage assembly with respect to the storage media of the retained media cartridge. The storage drive also has a head locking lever for locking the carriage assembly in a retracted position and unlocking same, and a multi-coil solenoid for actuating the head locking lever.

### FIELD OF THE INVENTION

The present invention relates to a disk drive having a solenoid with multiple coils. More particularly, the present invention relates to such a disk drive were the multi-coil solenoid actuates multiple functions.

### BACKGROUND OF THE INVENTION

A disk drive for receiving a removable disk is known. Examples of a disk drive include a conventional 3.5 inch ‘floppy’ disk drive, a ZIP disk drive as developed and marketed by IOMEGA Corporation of Roy, Utah, and the like. Such a disk drive is typically coupled to a processor or the like, and facilitates an exchange of information between the processor and the disk. The disk and the disk drive may be magnetically or optically based, for example.

The aforementioned disk may be housed within a disk cartridge, and can rotate freely within the cartridge. The disk may be mounted on a coaxial hub or may define a coaxial aperture, and the hub or aperture of the disk is externally accessible by way of an access aperture defined in one of the planar panels of the cartridge. Typically, the disk drive includes a frame or chassis and a disk motor which is mounted thereto, wherein during operation of the drive, the motor engages the hub or aperture of the disk through the cartridge access aperture and applies a rotating force to the disk by way of such hub or aperture.

The disk may be inserted into, retained within, and ejected from the disk drive by way of any of a variety of mechanisms. In at least some arrangements, the ejection aspect of the mechanism includes a lever or the like, and is actuated by way of a plunger of a solenoid contacting and appropriately moving the lever or the like. Ejection of a disk or disk cartridge is generally known or should be apparent to the relevant public and therefore need not be discussed herein in any detail.

As retained within the disk drive, the disk is brought into contact with one or more read/write heads for reading data from and/or writing data to the disk. The heads are moved relative to the disk by a head assembly which includes the heads. Typically, the head assembly moves the heads to a retracted position and locks the heads in such retracted position when the heads are not expected to be active. Accordingly, the non-active heads are protected from damage and the like. In at least some arrangements, and similarly, to release the locked heads, the head assembly includes a lever or the like that is actuated by way of a plunger of a solenoid contacting and appropriately moving the lever or the like. Releasing a locked head assembly is generally known or should be apparent to the relevant public and therefore need not be discussed herein in any detail.

Also, prior to ejecting the disk, the head assembly typically retracts or moves the heads away from the disk to avoid damage to the heads and the disk during such ejection. In at least some arrangements, the retraction aspect of the head assembly is embodied as a lever or the like, and is actuated by way of a plunger of a solenoid contacting and appropriately moving the lever or the like. Retraction of a head assembly is generally known or should be apparent to the relevant public and therefore need not be discussed herein in any detail. Typically, the retraction lever or the like of the head assembly and the head release lever or the like of the head assembly are separate (although they could be one and the same), ejection occurs by moving the lever a relatively large distance, and head lock/release occurs by moving the lever a relatively small distance.

Typically, the solenoid and plunger that actuates the ejection lever or the like is also the solenoid and plunger that actuates the retraction lever and head release lever, and such solenoid and plunger actuates ejection after actuating head lock/release. Actuating head lock/release may be accomplished with a relatively short stroke of the plunger by the solenoid, and actuating ejection may be accomplished with a relatively long stroke of the plunger by the solenoid. A solenoid and a disk drive having such a solenoid is set forth in more detail in U.S. Pat. No. 5,650,891, hereby incorporated by reference in its entirety.

Preferably, a disk drive mounted to a computer by way of a host port of the computer is powered through the host port and therefore does not require an external power supply. However, a solenoid such as the retraction/ejection/head release solenoid discussed above typically requires a relatively high operating current that is either a strain on the host port of a computer or that is not available from the host port of a computer.

Preferably, the solenoid as mounted to the disk drive is relatively short in height so that the overall disk drive can have a relatively small height (i.e., in a direction generally normal to the general planar extent of the disk drive). However, a solenoid such as the retraction/ejection/head release solenoid discussed above typically is relatively tall in height in order to generate the kind of magnetic flux necessary to actuate the plunger, especially for a relatively long plunger stroke.

Accordingly, a need exists for a disk drive having a solenoid with relatively low operating current and a relatively low height.

### SUMMARY OF THE INVENTION

The present invention satisfies the aforementioned need by providing a storage drive for receiving thereinto, retaining, and ejecting therefrom a removable storage media cartridge having storage media. The storage drive has an actuator including a carriage assembly with a head mounted thereto. The actuator moves the head as mounted to the carriage assembly with respect to the storage media of the retained media cartridge. The storage drive also has a head locking lever for locking the carriage assembly in a retracted position and unlocking same, and a multi-coil solenoid for actuating the head locking lever.

### BRIEF DESCRIPTION OF THE DRAWINGS

The foregoing summary as well as the following detailed description of the present invention will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a perspective view of a typical data storage device, or disk drive;

FIG. 2 is a perspective view of a disk cartridge for use with the disk drive of FIG. 1;

FIG. 3 is a bottom view of the disk cartridge of FIG. 2;

FIG. 4 is a top view of the data storage device of FIG. 3 with a top cover of the device housing removed;

FIGS. 5-7 are top views of the data storage device of FIG. 4 illustrating the insertion of a disk cartridge into the device;

FIG. 8 illustrates further details of a portion of the data storage device of FIG. 3;

FIGS. 9-12 illustrate further details of the operation of a first movable member and a second movable member in accordance with the present invention;

FIG. 13 is a perspective view of a portion of the data storage device of FIGS. 1-12, and in particular shows the single-coil solenoid thereof;

FIG. 14 is a top plan view of the single-coil solenoid of FIG. 13;

FIG. 15 is a schematic top plan view of the single-coil solenoid of FIG. 13;

FIG. 16 is a perspective view of a portion of a data storage device such as that of FIGS. 1-12, and in particular shows a multi-coil solenoid thereof in accordance with one embodiment of the present invention;

FIG. 17 is a perspective view of the multi-coil solenoid of FIG. 16; and

FIG. 18 is a schematic top plan view of the multi-coil solenoid of FIG. 16.

### DETAILED DESCRIPTION OF PREFERRED EMBODIMENTS

Certain terminology may be used in the following description for convenience only and is not considered to be limiting. For example, the words “left”, “right”, “upper”, and “lower” designate directions in the drawings to which 20 reference is made. Likewise, the words“inwardly” and“outwardly” are directions toward and away from, respectively, the geometric center of the referenced object. The terminology includes the words above specifically mentioned, derivatives thereof, and words of similar import.

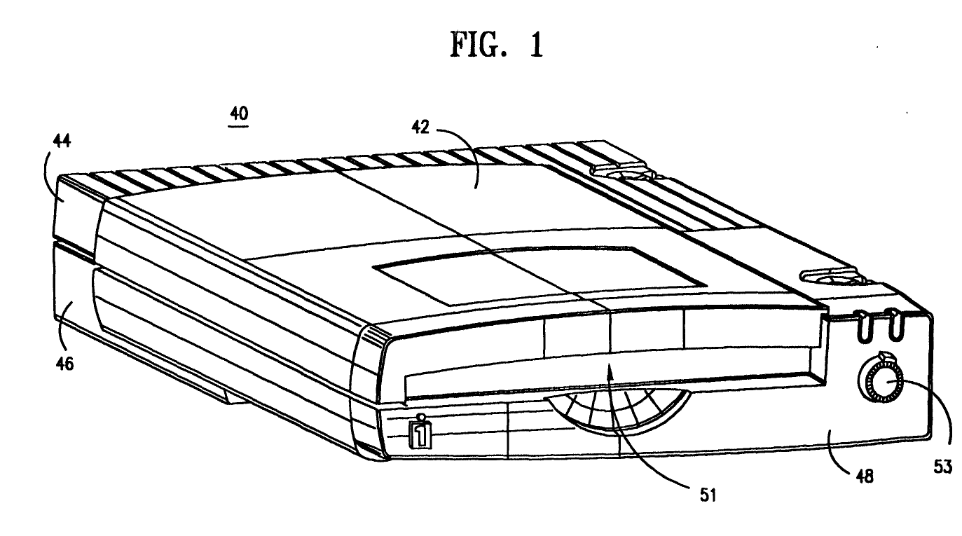

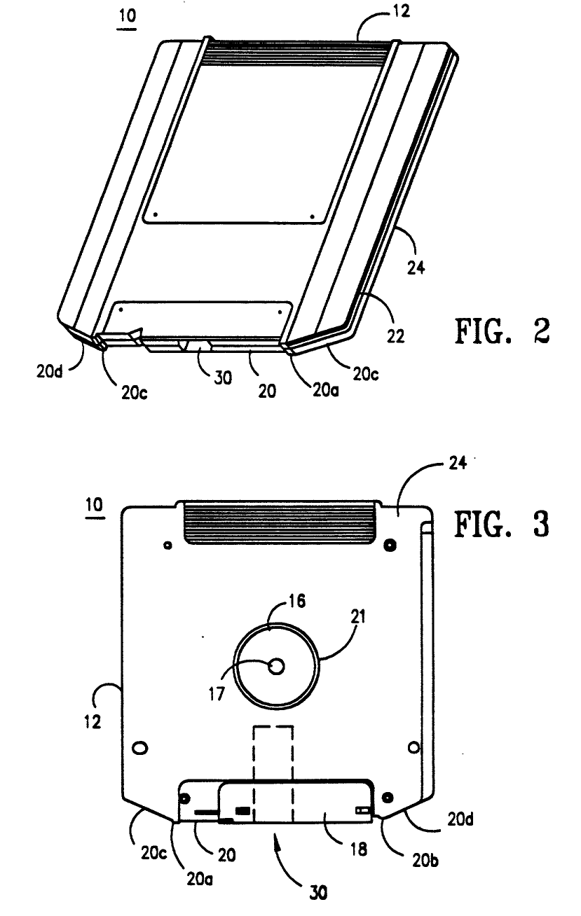

Referring now to FIG. 1, there is shown a typical disk drive 40. As was discussed above, the disk drive 40 is for receiving a removable disk (not shown) such as a conventional 3.5 inch ‘floppy’ disk or a“ZIP” disk as developed and marketed by IOMEGA Corporation of Roy, Utah, and the like. As seen, the disk drive 40 comprises an outer housing 42 having top and bottom covers 44, 46 and a front panel 48. A disk cartridge 10 (FIGS. 2 and 3) can be inserted into the disk drive 40 through a horizontal opening 51 in the front panel 48 of the disk drive 40. An eject button is also provided on the front panel for automatically ejecting a retained disk cartridge from the disk drive 40. The disk drive 40 shown in FIG.1 is a stand-alone unit, although the disk drive 40 of the present invention as disclosed below is particularly suited as an internal disk drive of a computer (not shown).

FIGS. 2 and 3 show an exemplary disk cartridge 10 adapted for use in the disk drive 40 of FIG. 1. As shown, the disk cartridge 10 comprises an outer casing 12 having upper and lower shells 22, 24 that mate to form the casing. A disk-shaped recording medium (not shown) is affixed to a hub 16 that is rotatably mounted in the casing 12. An opening 21 on the bottom shell 24 of the casing 12 provides access to the disk hub 16. A head access opening 30 in the front peripheral edge 20 of the disk cartridge 10 provides access to the recording surfaces of the disk (not shown) by the recording heads of the disk drive. A shutter 18 (not shown in FIG. 2) is provided on the front peripheral edge 20 of the disk cartridge 10 to cover the head access opening 30 when the cartridge is not in use. When the cartridge is inserted into the disk drive, the shutter 18 moves to the side exposing the head access opening 30 and thereby providing the heads of the drive with access to the recording surface of the disk (not shown). In the present embodiment, the casing houses a flexible or floppy magnetic disk, however, in other embodiments, the disk may comprise a rigid magnetic disk, a magneto-optical disk or an optical storage medium.

The opposite front corners of the disk cartridge 10 have a non-square shape defined by angled surfaces 20c, 20d that angle away from the front peripheral edge 20 of the cartridge at a predetermined angle. Additionally, a pair of projections 20a, 20b are formed on the front peripheral edge 20 of the cartridge. Each projection 20a, 20b is formed adjacent a respective one of the angled surfaces 20c, 20d at the point where the respective surface 20c, 20d begins to angle away from the plane of the front peripheral edge 20 of the cartridge 10.

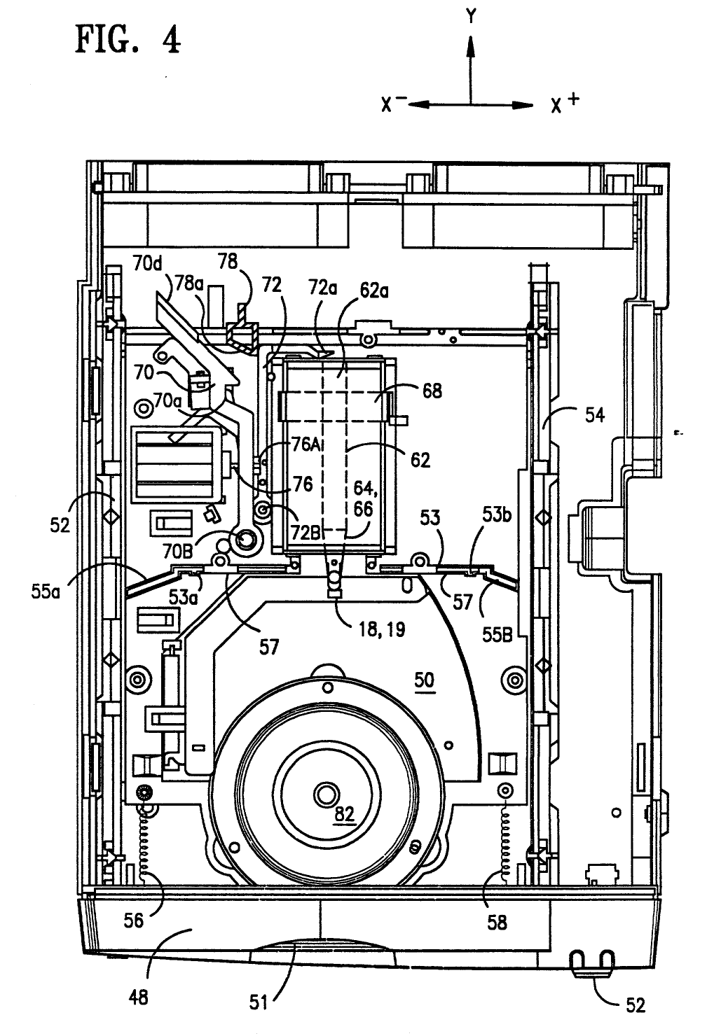

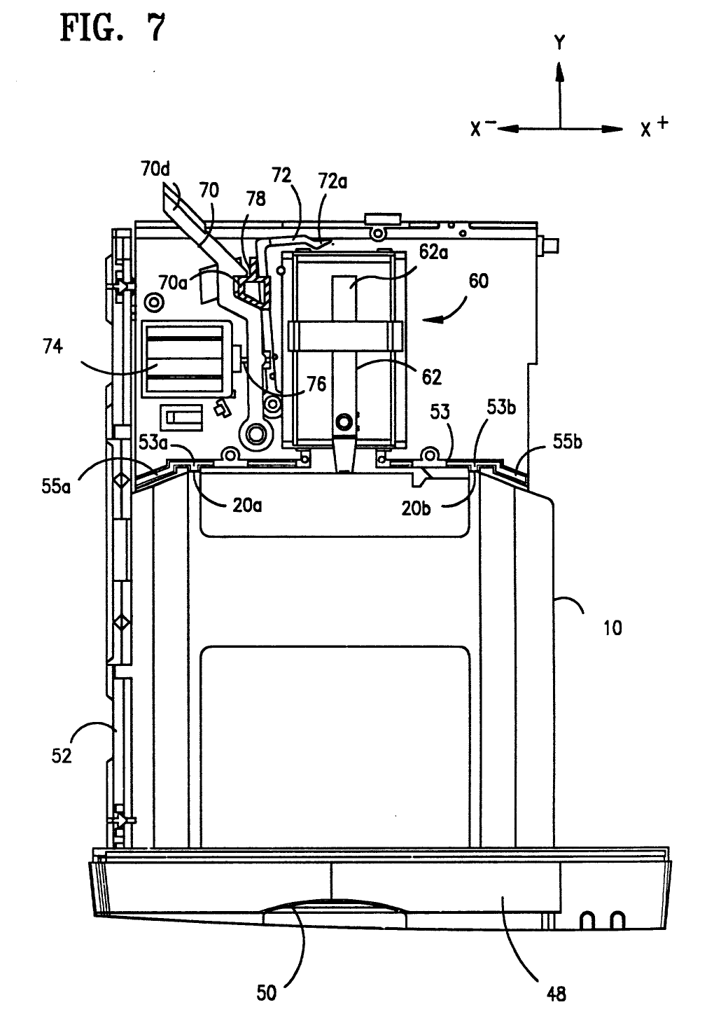

FIG. 4 is a top view of the disk drive 40 of FIG. 1 with the top cover 44 removed. The disk drive 40 comprises an internal platform 50 that slides along opposing side rails 52, 54 between a forward position (FIG. 4) and a rearward position (FIG. 7). A pair of springs 56, 58 bias the platform 50 toward its forward position.

An actuator 60, which in the preferred embodiment comprises a linear actuator, is mounted to the rear of the platform 50. The linear actuator 60 comprises a carriage assembly 62 having two lightweight flexible arms 64, 66. The recording heads 18,19 of the disk drive are mounted at the ends of the respective arms 64, 66. A coil 68, which is part of a voice coil motor, is mounted at the opposite end of the carriage 62. The coil 68 interacts with magnets (not shown) to move the carriage linearly so that the heads 18 and 19 can move radially over respective recording surfaces of a disk cartridge inserted into the disk drive.

A raised wall 53 is formed on the platform. The raised wall 53 extends across the width of the platform 50, perpendicularly to the direction of motion of the carriage 62. The raised wall 53 defines an eject member that engages the front peripheral edge 20 of the disk cartridge 10 upon insertion of the disk cartridge into the disk drive. The opposite side edges 55a, 55b of the eject member 53 are angled in the same manner as the opposite front corners 20c, 20d of the disk cartridge 10. Thus, the shape of the eject member 53 mirrors the contour of the forward end face of the cartridge. As further shown, the front surface 57 of the eject member 53 has a pair of projections 53a, 53b positioned near the angled surfaces 55a, 55b.

The disk drive 40 further comprises a spindle motor 82 capable of rotating the recording medium of a disk cartridge at a predetermined operating speed. In the present embodiment, the spindle motor 82 is coupled to the platform 50. When a disk cartridge is inserted into the disk drive, the hub 16 of the disk cartridge engages the spindle motor 82 of the disk drive 40 when the platform reaches its rearward position.

As embodied in the disk drive 40 illustrated herein, the disk drive 40 comprises a first movable member movably mounted in the disk drive for performing a respective function. In the embodiment described herein, the first movable member comprises an eject latch lever 70 movably mounted within the disk drive 40. As described hereinafter, the eject latch lever 70 functions to releasably latch the platform 50 in its rearward position. In the present embodiment, the eject latch lever 70 is pivotally mounted on the platform 50 about a rotation shaft 70b. A first spring (not shown) is coupled to the eject latch lever 70 (i.e., first movable member) at the rotation shaft 70b in order to bias the lever 70 in a first direction (e.g., the X+direction). The eject latch lever 70 has a cutout 70a adapted to releasably engage a latch projection 78 as the platform 50 moves backward into its rearward position. The biasing force of the first spring 90 urges the eject latch lever 70 into this latched position. In one embodiment, the latch projection 78 is formed as part of the top cover 44 (not shown) of the disk drive 40.

The disk drive 40 also comprises a second movable member movably mounted within the disk drive 40. In the embodiment described herein, the second movable member comprises a head locking lever 72 that is pivotally mounted on the platform 50 about a rotation shaft 72b. As described hereinafter, the head locking lever 72 functions to lock and unlock the carriage 62 of the linear actuator 60. A second spring (not shown) is coupled to the head locking lever 72 (i.e., second movable member) at its rotation shaft 72b to bias the head locking lever 72 in the same direction as the eject latch lever 70 (i.e., the X+direction). An end 72a of the head locking lever, which extends at a right angle to the main shaft of the lever 72, is adapted to releasably engage an end 62a of the actuator carriage 62 when the carriage 62 is in a fully retracted position, thereby locking the carriage in place and preventing inadvertent movement of the recording heads 18, 19.

A single electro-mechanical device comprising a solenoid 74 is mounted on the platform 50 and has a plunger 76. When the solenoid 74 is energized by an electrical current, the plunger 76 moves in the X−direction from a normally extended position toward a retracted position. As the plunger 76 of the solenoid 74 moves toward its retracted position, an enlarged operating end 76a of the plunger 76 engages the first and second movable members (e.g., eject latch and head locking levers 70, 72) in order to pull the members in the X−direction against the respective biasing forces of the first and second springs 90, 92.

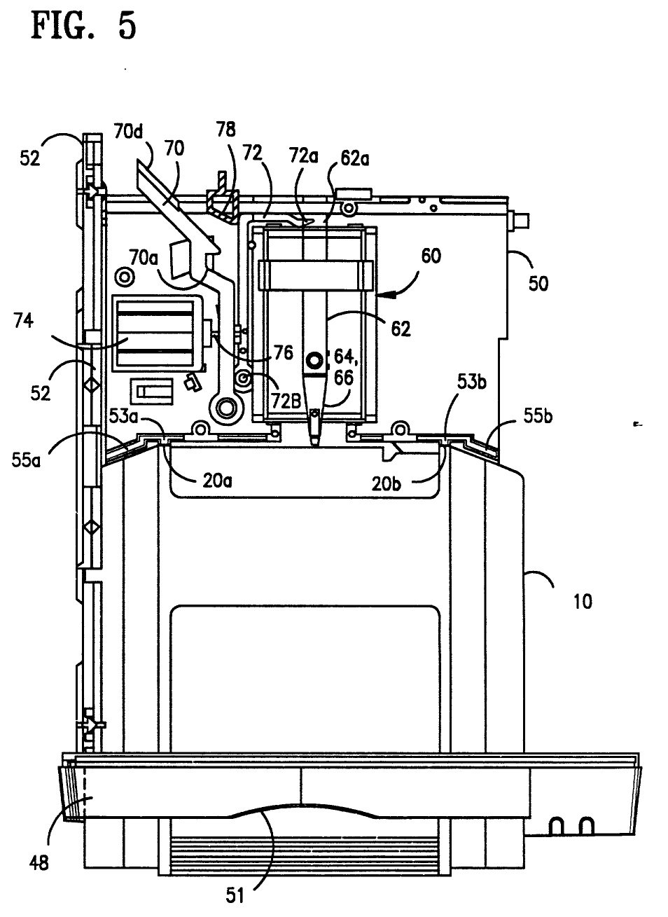

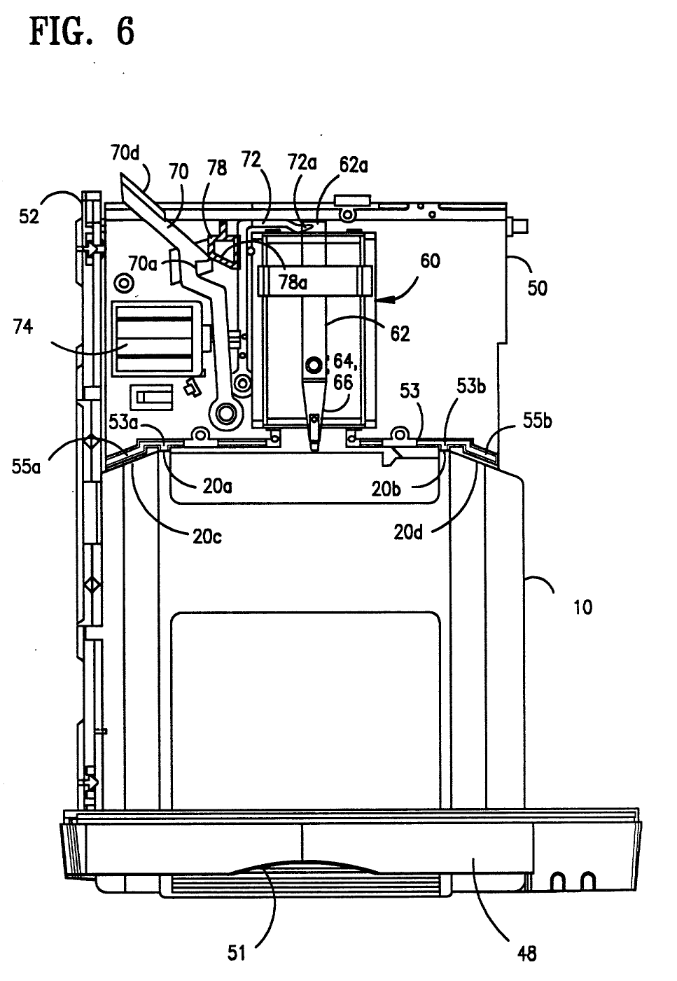

FIGS. 5-7 illustrate the insertion of a disk cartridge 10 into the disk drive 40. For purposes of illustration only, some components of the disk drive 40 are not shown. Referring to FIG. 5, a disk cartridge 10 is inserted into the disk drive 40 through the opening 51 in the front panel 48 of the disk drive 40. Initially, the platform 50 is in its forward position, as shown. As the disk cartridge 10 is pushed farther into the disk drive 40, the pair of projections 20a, 20b on the forward end 20 of the cartridge 10 engage the corresponding pair of projections 53a, 53b on the front surface of the eject member 53 of the platform 50. Thereafter, the disk cartridge 10 and platform 50, including the eject member 53, move together rearwardly against the biasing force of the springs 56, 58 (FIG. 4).

The platform 50 rides in slots (not shown) along the opposing side rails 52, 54. The slots (not shown) in the opposing side rails 52, 54 are contoured such that, as the platform 50 and disk cartridge 10 move rearwardly, the elevation of the platform 50 changes. Specifically, the platform 50 rises in order to bring the spindle motor 82 of the disk drive 40 into engagement with the hub 16 of the disk cartridge 10. Engagement of the hub 16 and spindle motor 82 is completed when the platform 50 reaches its final rearward position (FIG. 7).

Referring to FIG. 6, as the platform 50 approaches its rearward position, the portion of the eject latch lever 70 just rearward of the cutout 70a contacts an angled surface 78a of the latch projection 78. As the disk cartridge 10 pushes the platform 50 farther to the rear of the disk drive, the eject latch lever 70 rides along the angled surface 78a pushing the eject latch lever 70 to the side (i.e., X−direction) against its normal spring bias. As shown in FIG. 7, when the platform reaches its full rearward position, the eject latch lever 70 springs back in the X+direction such that the cutout 70a engages the latch projection 78. This latches the platform 50, and hence the eject member 53, in its rearward position and maintains the disk cartridge 10 in the disk drive 40. In this manner, the eject latch lever is said to be self-latching.

The eject member 53 may alternately be formed separately from the platform 50 and the platform 50 may be stationary. In such case, the eject member 53 alone will move from the forward position to the rearward position, and the eject latch lever 70 will be adapted to latch the eject member 53 in its rearward position. Also alternately, the platform 50 may be omitted.

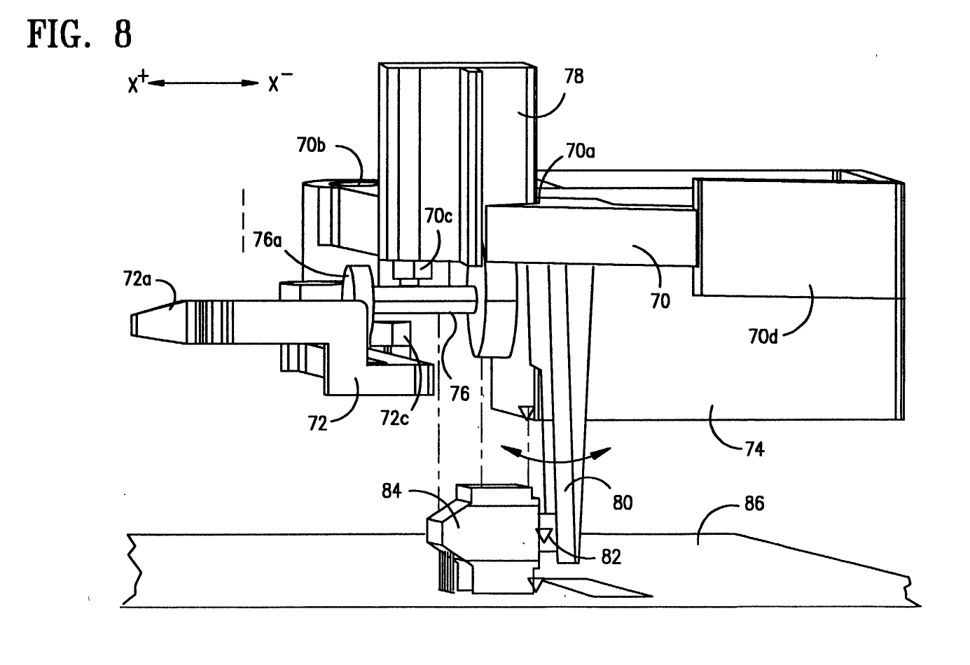

FIG. 8 is a rear end view of the disk drive 40 illustrating the latched position of the eject lever 70. As shown, the eject lever 70 has an elongate, downwardly extending projection 80 that extends downwardly from the lever 70 toward a circuit board 86 mounted on the bottom cover 46 of the disk drive housing. A switch 84 having a plunger 82 is mounted on the circuit board 86. When the platform 50 reaches the rearward position and the cutout 70a engages the latch projection 78, the projection 80 extending from the eject lever 70 moves against the plunger 82 thereby activating the switch 84. A controller (not shown) in the disk drive can sense the activation of the switch 84 and be alerted that the platform 50 has moved into the latched, rearward position. The controller can then initiate rotation of the spindle motor and can signal the solenoid 74 to move the head locking lever 72 and release the linear actuator.

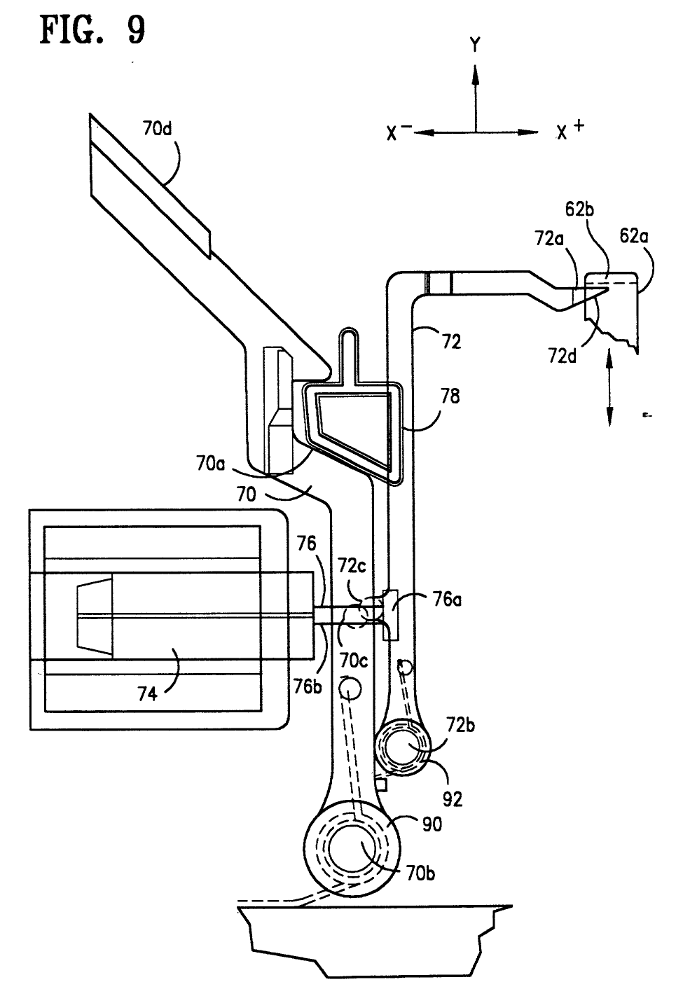

Referring now to FIGS. 9-12, the structure and operation of the solenoid 74 and the first and second movable members (i.e., levers 70, 72) is described in greater detail. The single solenoid 74 is adapted to move the first and second members independently in order to selectively perform their respective functions. In particular, the solenoid is adapted to move the eject latch lever 70 (i.e., first member) and head locking lever 72 (i.e., second member) in order to selectively unlatch the platform 50 and/or unlock the carriage of the head actuator 53. It is understood that the eject latch and head locking levers 70, 72 shown represent merely one implementation. Alternately, the first and second movable members may comprise other movable components adapted to perform other disk drive functions. The following discussion of the operation of the eject latch and head locking levers 70, 72 is intended merely to illustrate one exemplary implementation.

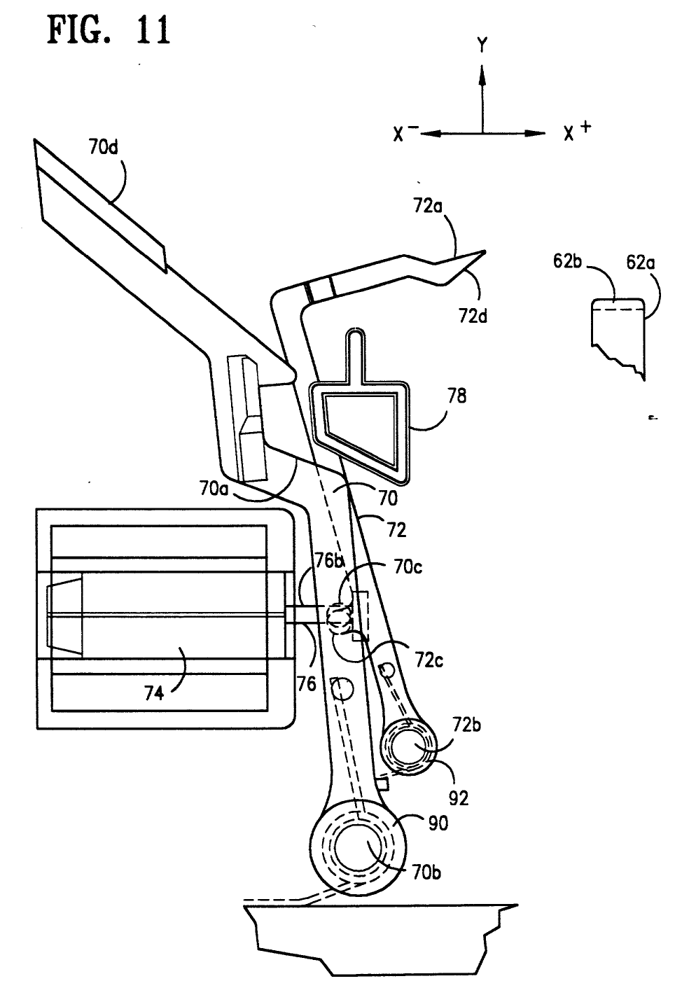

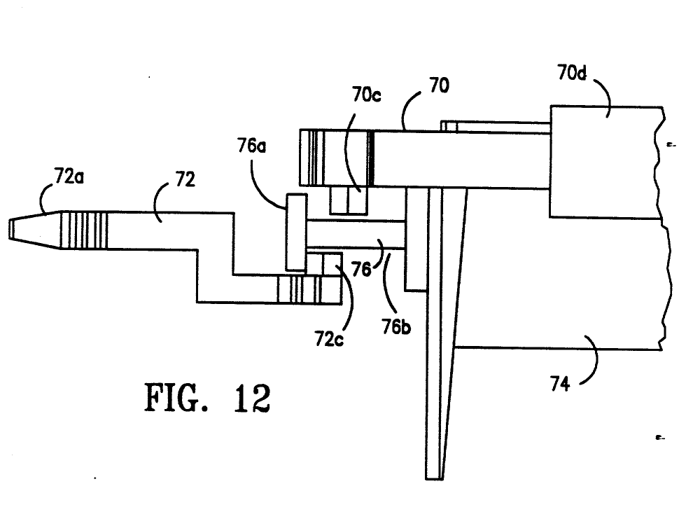

Each of the movable members (i.e., eject latch and head locking levers 70, 72) has a small projection 70c, 72c positioned in the path of movement of the enlarged end 76a of the solenoid shaft 76. As the plunger 76 of the solenoid moves in the X−direction from its normally extended position (FIG. 9) to its fully retracted position (FIG. 11), the enlarged end 76a of the plunger 76 engages with the respective projections 70c, 72c on the levers 70, 72, moving the levers 70, 72 against the respective biasing forces of the first and second springs 90, 92.

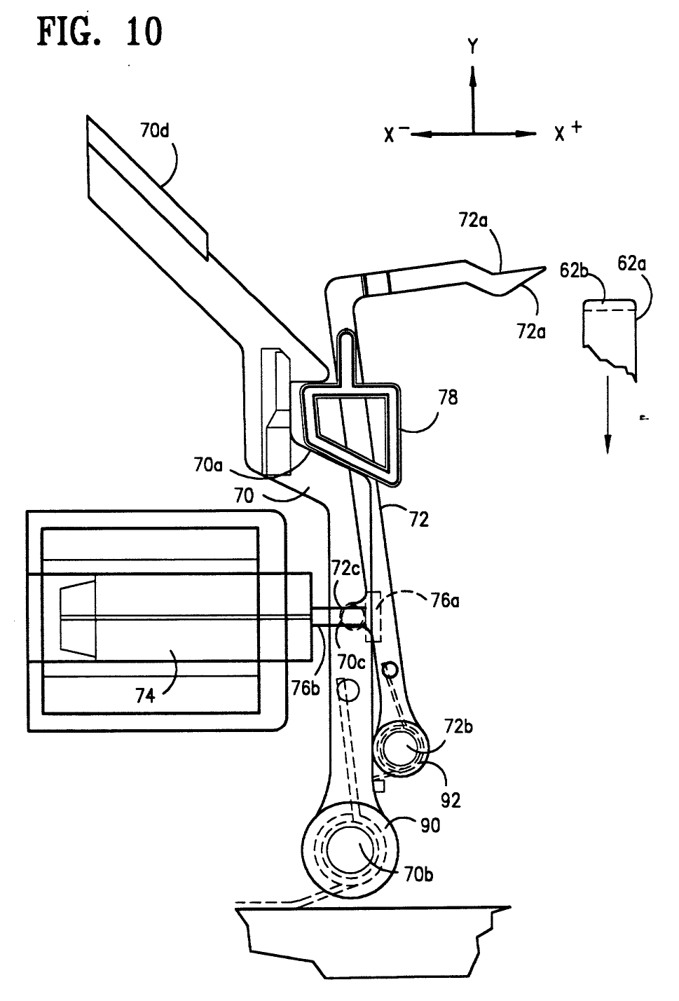

As best shown in FIGS. 9 and 12, the respective projections 70c, 72c are positioned relative to the enlarged end 76a of the plunger 76 such that the end 76a of the plunger will contact the projection 72c on the head locking lever 72 (i.e., first movable member) first and will move the head locking lever 72 a predetermined distance to an intermediate position (FIG. 10) of the plunger 76 before engaging the projection 70c on the eject lever 70. As such, the head locking lever 72 can be moved independently of the eject lever 70.

The biasing force of the first spring 90 is greater than the biasing force of the second spring 92. As such, the solenoid 74 can be energized with an electrical signal having a first current that is sufficient to move the plunger 76 of the solenoid 74 against the biasing force of the second spring 92 but is insufficient to move the plunger 76 against the biasing force of the first spring 92. As shown in FIG. 10, when it is desired to unlock the carriage 62 of the head actuator 60, an electrical signal having this first current can be applied to the solenoid 74 causing the plunger 76 of the solenoid 74 to move in the X−direction pulling the head locking lever 72 out of engagement with the end 62a of the actuator carriage 62. However, because the first current is insufficient to overcome the biasing force of the first spring 90, the plunger 76 will stop moving when the enlarged end 76a of the plunger 76 reaches its intermediate position and contacts the projection 70c on the eject latch lever 70. Thus, in this case, the head locking lever 72 moves to a disengaged position, while the eject lever 70 remains in its latched position. Once the actuator carriage 62 has moved forward and begun its normal operation, the first current can be removed from the solenoid 74 allowing the plunger 76 of the solenoid 74 to move back to its extended position (FIG. 9). At the same time, the second spring 92 will urge the head locking lever 72 back to the position shown in FIG. 9.

Like the eject latch lever 70, the head locking lever 72 is self-latching or self-engaging. That is, when the head locking lever 72 is in the position shown in FIG. 9 and the rear end 62a of the carriage 62 moves back toward the rear of the disk drive, the rear end 62a contacts an inclined surface 72d at the end 72a of the lever 72. As the carriage 62 moves farther to the rear, the end 62a of the carriage will ride along the inclined surface 72d of the head locking lever 72 causing the head locking lever 72 to move to the side against the bias of spring 92. Once the carriage 62 reaches its full rearward position, the head locking lever 72 will spring back to its engaged position, and the carriage 62 will once again be locked in place, as illustrated in FIG. 9. More specifically, as shown in FIG. 9, the end 72a of the head locking lever 72 locks the carriage 62 in place (i.e., engages the carriage 62) by blocking the rear end surface 62b of the carriage 62. It is desirable to lock the carriage in place whenever the disk drive 40 is not in use, or a disk cartridge has been removed from the disk drive 40.

Referring now to FIG. 11, when it is desired to eject a disk cartridge from the disk drive, the eject button 52 on the front panel 48 of the disk drive 40 is pushed. A processor (not shown) in the disk drive detects the activation of the eject button and applies an electrical signal to the solenoid 74 having a second, stronger current than the first current that is sufficient to overcome the combined biasing force of both the springs 90, 92. In this case, the plunger 76 of the solenoid 74 moves from its extended position to its fully retracted position. As the plunger 76 moves to its fully retracted position, the enlarged operating end 76a of the plunger engages the projections 70c, 72c on both levers 70, 72 pulling both levers in the X−direction. This causes the cutout 70a on the eject latch lever 70 to disengage from the latch projection 78, thereby releasing the platform 50 (i.e., eject member 53). Once released, the platform 50 moves back to its forward position under the force of springs 56, 58. As the platform 50 moves back to the forward position, the disk cartridge is backed out of the opening 51 and can then be removed by a user. Immediately after unlatching the platform 50, the second current is removed from the solenoid 74 so that the eject latch lever 70 and head locking lever 72 spring back to the positions shown in FIG. 5.

The magnitudes of the first and second currents required to overcome the biasing forces of the first and second springs are highly dependent on the characteristics of the particular solenoid employed. Significantly, though, the maximum current required by the solenoid 74 of the typical disk drive 40 is believed to be relatively high as compared to the maximum current available to the disk drive 10 from a host port of a typical computer. Thus, the disk drive 40 in an internal configuration (not shown) may require an external power supply.

Additionally, the solenoid 74 as mounted to the disk drive is relatively tall in height so that the overall disk drive 40 is relatively tall (i.e., in a direction generally normal to the general planar extent of the disk drive). Thus, the disk drive 40 in an internal configuration (not shown) may require excessive height space within a typical computer housing.

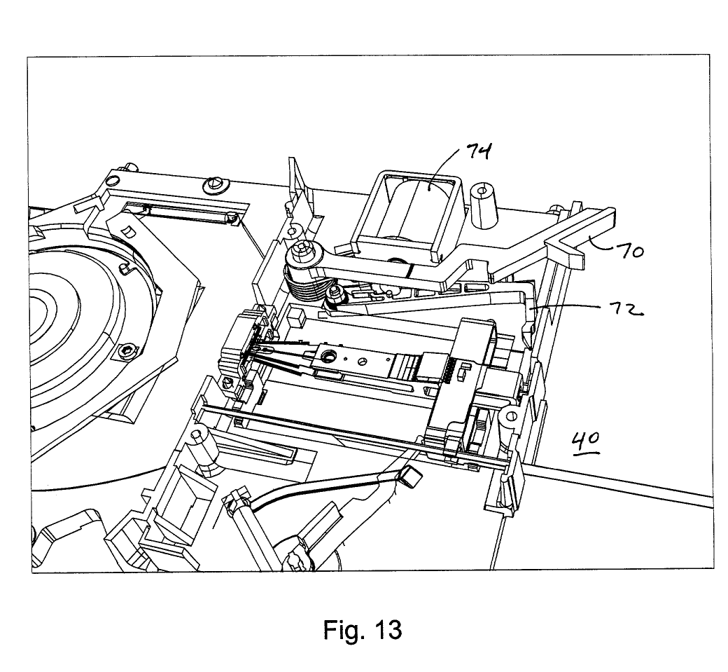

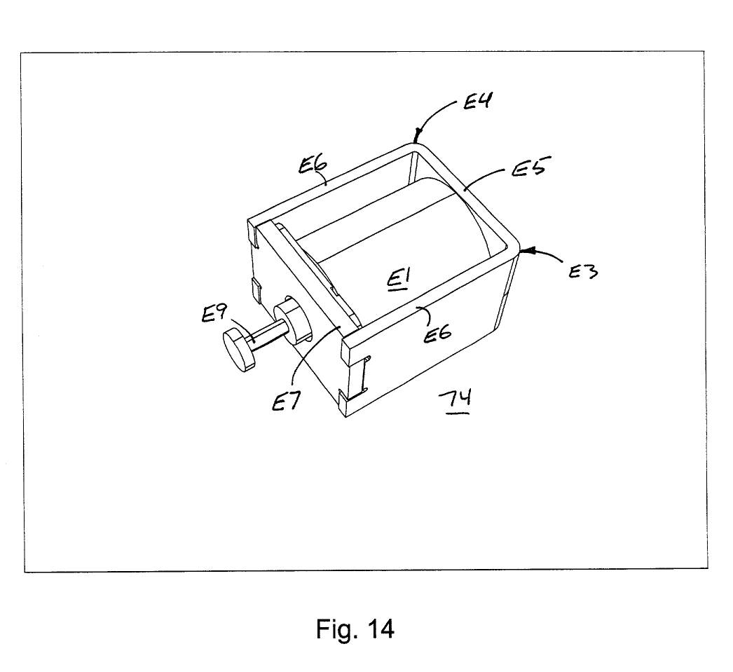

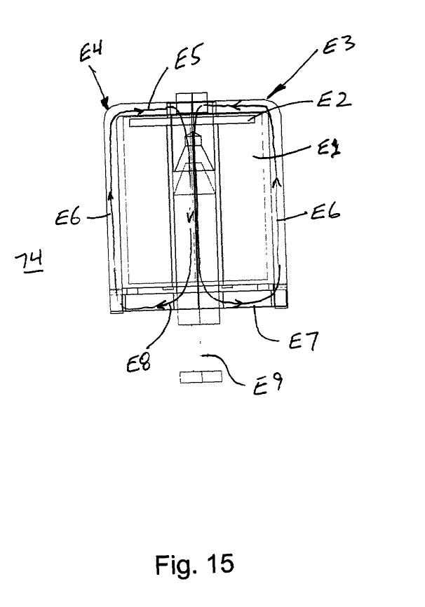

Referring now to FIGS. 13-15, the solenoid 74 of the disk drive 40 of FIGS. 1-12 is shown in more detail. In particular, and as seen, the solenoid 74 is an open frame single-coil solenoid and has the aforementioned single coil E1 wrapped on a bobbin E2, where the bobbin E2 with coil E1 is mounted to a frame E3. Such frame E3 includes a generally U-shaped first piece E4 having a rear portion E5 and side portions E6, and a second piece E7 comprising a front portion. As may be appreciated, the distal ends of the side portions E6 are coupled to the ends of the second piece E7 such that the frame E3 is generally rectangular. As may also be appreciated, the bobbin E2 with coil E1 is mounted to the frame E3 such that the axis of the coil E1 is generally interposed between and extends generally parallel with the side portions E6 of the first piece E4 of the frame E3.

In operation, the coil E1 is energized to develop a flux path E8 that extends down the axis of the coil E1 toward the second piece E7 of the frame E3, then through the second piece E7 toward each end thereof, then up each side portion E6 toward the rear portion E5, then through the rear portion E5 from each side portion E6 and toward the central area of such rear portion E5, and then back down the axis of the coil E1. With such flux path E8, then, a plunger E9 mounted to the second piece E7 of the frame is drawn up the axis of the coil El and within the coil E1, bobbin E2, and frame E3. Note that such flux path E8 includes a split where the flux diverges in the second piece E7.

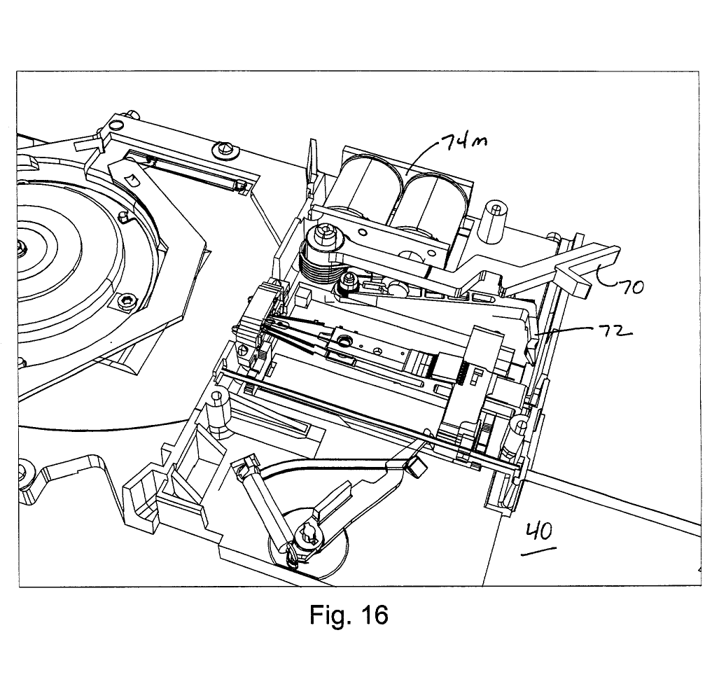

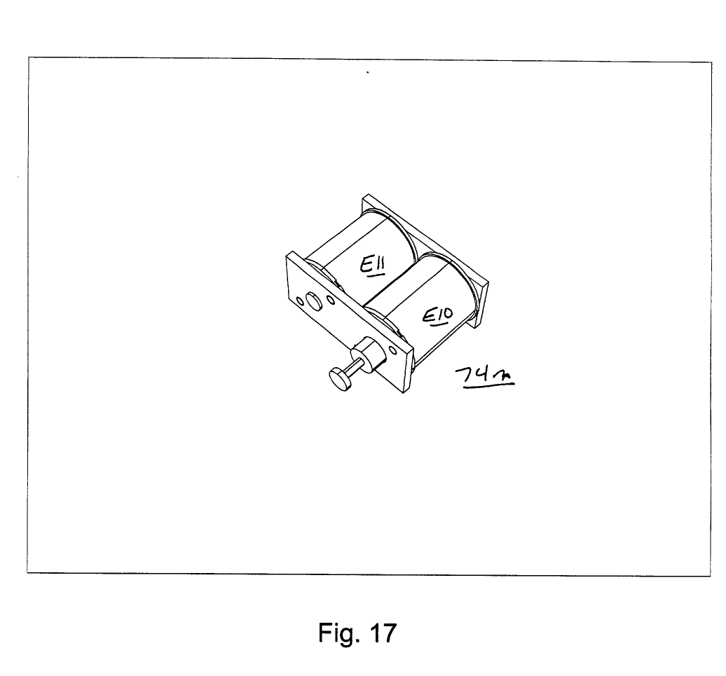

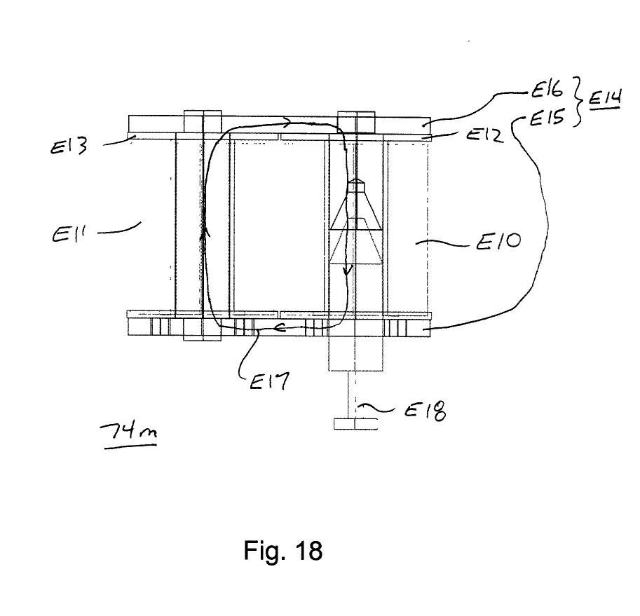

In one embodiment of the present invention, to reduce the maximum current required by the solenoid of the typical disk drive 40, and/or to reduce the height of the solenoid of the typical disk drive 40, the single-coil solenoid 74 of FIGS. 1-15 is replaced by a multi-coil solenoid 74m, as in FIGS. 16-18. In particular, and as seen, the multi-coil solenoid 74m has a pair of coils E10, E11 wrapped on respective bobbins E12, E13, where each bobbin E12, E13 with respective coils E10, E11 is mounted to a frame E14 in a side-by-side manner.

Here, the frame E14 includes a front plate E15 and a back plate E16, but does not include any side portions as with the solenoid 74 of FIGS. 1-1 5. As may be appreciated, the front plate E15 and the back plate E16 do not physically contact one another. As may also be appreciated, the bobbins E12, E13 with coils E10, E11 are mounted to the frame E14 such that the axes of the coils E10, E11 are generally parallel to one another and are generally normal to the planar extents of each of the front plate E15 and the back plate E16.

In operation, the coils E10, E11 are energized to develop a flux path E17 that extends down the axis of the coil E10 toward the front plate E15, across the front plate E15 toward the axis of the coil E11, up the axis of the coil E11 toward the back plate E16, across the back plate E16 toward the axis of the coil E10, and then back down the axis of the coil E10. With such flux path E17, then, a plunger E18 mounted to the front plate E15 of the frame E14 is drawn up the axis of the coil E10 and within the coil E10 and bobbin E12. Note that such flux path E17 is a single loop and therefore includes no split such as in the case of the flux path E8 of the solenoid 74 of FIGS. 1-15.

Note that in operating the coils E10, E11, actuation of the head lock lever 72 only and not the eject lever 70 may be achieved by applying a relatively lesser current to both coils E10, E11, and actuation of both the head lock lever 72 and the eject lever 70 may be achieved by applying a relatively greater current to both coils E10, E11. Alternatively, actuation of the head lock lever 72 only and not the eject lever 70 may be achieved by applying a current to one of the coils E10, E11, and actuation of both the head lock lever 72 and the eject lever 70 may be achieved by applying a current to both coils E10, E11. The amounts of current applied vary based on the particulars of the solenoid 74m, and at any rate in any particular situation are known or should be apparent to the relevant public and therefore need not be described herein in any detail.

Importantly, to produce the same effect on the respective plungers E9, E18, the multiple coils E10, E11 of the solenoid 74m of the present invention as shown in FIGS. 16-18 operate at a maximum current that is significantly less than the maximum current of the single coil E1 of the solenoid 74 of FIGS. 1-15. That is, the multiple coils E10, E11 and the overall design of the solenoid 74m of the present invention as shown in FIGS. 16-18 are more efficient than the single coil E1 of the solenoid 74 of FIGS. 1-15. In fact, it has been shown empirically that the maximum current employed by the multiple coils E10, E11 of the solenoid 74m of the present invention as shown in FIGS. 16-18 is about one-third that of the maximum current employed by the single coil E1 of the solenoid 74 of FIGS. 1-1 5. Accordingly, a disk drive 40 having the solenoid 74m of the present invention is more amenable to being supplied with power solely through the host port of a typical computer, and is less susceptible to the need for an external power source.

Also importantly, the solenoid 74m of the present invention having the multiple coils E10, E11 can be constructed to have a smaller height (i.e., in a direction generally normal to the general planar extent of the disk drive 40) as compared to the solenoid 74 having the single coil E1, and/or can be constructed to require less current as compared to the solenoid 74. In particular, the coils E10, E11 may have less windings than the coil E1, in which case the coils E10, E11 are shorter, may have more windings than the coil E1, in which case the coils E10, E11 use less current, or a combination thereof. Thus, a disk drive 40 having the solenoid 74m of the present invention may be constructed to have a smaller height as compared with a disk drive 40 having the solenoid 74, and/or may be constructed to use less current.

In the foregoing description, it can be seen that the present invention comprises a new and useful solenoid 74m and disk drive 40 having such solenoid 74m, where the solenoid 74m has a relatively low operating current and a relatively low height. It should be appreciated that changes could be made to the embodiments described above without departing from the inventive concepts thereof. It should be understood, therefore, that this invention is not limited to the particular embodiments disclosed, but it is intended to cover modifications within the spirit and scope of the present invention as defined by the appended claims.

1. A storage drive for receiving thereinto, retaining, and ejecting therefrom a removable storage media cartridge having storage media, the storage drive comprising:
an actuator including a carriage assembly with a head mounted thereto, the actuator for moving the head as mounted to the carriage assembly with respect to the storage media of the retained media cartridge;
a head locking lever for locking the carriage assembly in a retracted position and unlocking same; and
a multi-coil solenoid for actuating the head locking lever.

2. The storage drive of claim 1 further comprising:
an internal platform movable between a forward position and a rearward position, the platform for receiving the media cartridge in the forward position, retaining the media cartridge in the rearward position, and ejecting the media cartridge during movement from the rearward position to the forward position; and
an eject latch lever for releasably latching the platform in the rearward position;
the multi-coil solenoid for actuating the eject latch lever and the head locking lever.

3. The storage device of claim 2 wherein in operation, the coils actuate the head lock lever only and not the eject lever by application of a relatively lesser current to both coils, and the coils actuate both the head lock lever and the eject lever by application of a relatively greater current to both coils.

4. The storage device of claim 2 wherein in operation, the coils actuate the head lock lever only and not the eject lever by application of a current to one coil, and the coils actuate both the head lock lever and the eject lever by application of a current to both coils.

5. The storage drive of claim 1 comprising a disk drive for receiving thereinto, retaining, and ejecting therefrom a removable storage disk cartridge having a storage disk.

6. The storage drive of claim 1 wherein the multi-coil solenoid comprises a pair of coils each mounted to a frame in a side-by-side manner.

7. The storage drive of claim 6 wherein each coil has an axis and wherein the frame includes a front plate and a back plate and the coils are mounted to the frame such that the axes of the coils are generally parallel to one another and are generally normal to the front plate and the back plate.

8. The storage device of claim 7 wherein in operation, the coils as energized develop a flux path that extends down the axis of one coil toward the front plate, across the front plate toward the axis of the other coil, up the axis of the other coil toward the back plate, across the back plate toward the axis of the one coil, and then back down the axis of the one coil.

9. The storage device of claim 8 wherein the solenoid further comprises a plunger mounted along the axis of the one coil, whereby the plunger is drawn up the axis of and within the one coil.

10. A multi-coil solenoid for use in a storage drive for receiving thereinto, retaining, and ejecting therefrom a removable storage media cartridge having storage media, the storage drive comprising:
an actuator including a carriage assembly with a head mounted thereto, the actuator for moving the head as mounted to the carriage assembly with respect to the storage media of the retained media cartridge; and
a head locking lever for locking the carriage assembly in a retracted position and unlocking same, the multi-coil solenoid for actuating the head locking lever and comprising a pair of coils each mounted to a frame in a side-by-side manner.

11. The multi-coil solenoid of claim 10 wherein the storage drive further comprises:
an internal platform movable between a forward position and a rearward position, the platform for receiving the media cartridge in the forward position, retaining the media cartridge in the rearward position, and ejecting the media cartridge during movement from the rearward position to the forward position; and
an eject latch lever for releasably latching the platform in the rearward position,
the multi-coil solenoid for actuating the eject latch lever and the head locking lever, wherein in operation, the coils actuate the head lock lever only and not the eject lever by application of a relatively lesser current to both coils, and the coils actuate both the head lock lever and the eject lever by application of a relatively greater current to both coils.

12. The multi-coil solenoid of claim 10 wherein the storage drive further comprises:
an internal platform movable between a forward position and a rearward position, the platform for receiving the media cartridge in the forward position, retaining the media cartridge in the rearward position, and ejecting the media cartridge during movement from the rearward position to the forward position; and
an eject latch lever for releasably latching the platform in the rearward position,
the multi-coil solenoid for actuating the eject latch lever and the head locking lever, wherein in operation, the coils actuate the head lock lever only and not the eject lever by application of a current to one coil, and the coils actuate both the head lock lever and the eject lever by application of a current to both coils.

13. The multi-coil solenoid of claim 10 wherein each coil has an axis and wherein the frame includes a front plate and a back plate and the coils are mounted to the frame such that the axes of the coils are generally parallel to one another and are generally normal to the front plate and the back plate.

14. The multi-coil solenoid of claim 13 wherein in operation, the coils as energized develop a flux path that extends down the axis of one coil toward the front plate, across the front plate toward the axis of the other coil, up the axis of the other coil toward the back plate, across the back plate toward the axis of the one coil, and then back down the axis of the one coil.

15. The multi-coil solenoid of claim 14 further comprising a plunger mounted along the axis of the one coil, whereby the plunger is drawn up the axis of and within the one coil.
